(19) United States
(12) Patent Application Publication
(10) Pub. No.: US 2026/0205304 A1
(43) Pub. Date: Jul. 16, 2026

(54) Blockchain-Enabled Decentralized Third-Party Identity Management for Secure and Transparent Access Control

(71) Applicant: Bank of America Corporation, Charlotte, NC (US)

(72) Inventors: Jemlin Lucas, Coppell, TX (US); Suryanarayana Adivi, Hyderabad (IN); Rajaram Vijayvergiya, Hyderabad (IN); Pushkar Taneja, Hyderabad (IN)

(21) Appl. No.: 19/019,772

(22) Filed: Jan. 14, 2025

(51) Int. Cl. H04L 9/32; H04L 9/00; H04L 9/30; H04L 9/40

(52) U.S. Cl. CPC H04L 9/3247; H04L 9/3066; H04L 9/40; H04L 9/50; H04L 2209/56

(57) ABSTRACT

Decentralized system for third-party identity management and access control, leveraging blockchain technology, decentralized identifiers (DIDs), verifiable credentials (VCs), and cryptographic methods are disclosed. Third-party entities generate unique, self-owned DIDs, which are stored on a blockchain to ensure immutability and security. Verifiable credentials issued by trusted authorities, such as banks or regulatory bodies, encapsulate specific attributes, roles, or permissions and are similarly stored on the blockchain for tamper-proof verification. A public key infrastructure (PKI) is integrated to support secure authentication and cryptographic validation, ensuring trusted interactions between entities. The system features an API gateway that verifies DIDs and VCs, enforces granular access controls, and supports temporal access restrictions. By decentralizing identity management, the invention eliminates reliance on centralized repositories, enhances data integrity through an immutable ledger, and ensures distributed trust. It accommodates both human and non-human users, providing a scalable and secure framework for identity and access management across diverse applications.

### TECHNICAL FIELD

The inventions disclosed herein pertain to the field of cryptographic data processing systems or devices. This field includes systems and devices that utilize cryptographic techniques to secure data, authenticate entities, and provide integrity to digital communications. The invention employs public key cryptography, blockchain technology, and tamper-proof logging mechanisms to ensure secure identity management and access control. By integrating cryptographic methods into decentralized identity frameworks and verifiable credentials, the invention enables robust protection against unauthorized access, data breaches, and identity tampering, making it directly applicable to this technical field.

### DESCRIPTION OF THE RELATED ART

The issue at hand pertains to the inherent vulnerabilities and inefficiencies in traditional methods of managing third-party access to sensitive systems, particularly within highly regulated domains such as banking and finance. When external entities such as vendors, startups, or regulators require access to internal systems, the existing mechanisms often rely on either public identity providers or internally managed authentication processes. Public identity providers, while convenient, fail to establish a reliable level of trustworthiness and credibility due to their limited ability to verify the security posture of these entities. On the other hand, internal authentication processes are resource-intensive, requiring extensive infrastructure, monitoring teams, and operational overhead, which imposes significant financial and logistical burdens on organizations.

In cases where external access is essential for operational workflows, such as digital payment startups interfacing with internal banking systems, the potential for unauthorized access becomes a pressing concern. Sensitive information, including customer account details, is exposed to potential attacks, leading to financial fraud, reputational damage, and loss of customer trust. Additionally, the lack of a robust system for third-party authentication introduces inefficiencies, delays, and a lack of accountability in access control mechanisms. The absence of a tamper-proof and universally verifiable system further exacerbates these challenges, as reliance on centralized repositories introduces single points of failure.

Organizations face difficulties in establishing and maintaining a balance between enabling seamless access for legitimate third parties and safeguarding sensitive internal resources. For instance, in scenarios involving startups needing system integration for real-time payment processing, existing systems lack a streamlined and secure approach to validating the identity and roles of these entities. Such gaps leave room for malicious actors to impersonate trusted entities, accessing and misusing critical data. Moreover, the manual and fragmented processes used to establish trust between parties often result in inconsistencies and human errors, further compromising the integrity of these transactions.

Another significant concern is the inability to provide granular access control based on specific roles and temporal limitations. Current systems often grant broad and unrestricted access to external entities, inadvertently exposing resources beyond what is required for the task at hand. This lack of precision increases the risk of data breaches and misuse, as well as complicates audit trails. Furthermore, regulatory compliance becomes a daunting task when existing systems fail to provide transparent and immutable records of access and actions taken by third parties.

In regulatory and audit scenarios, the challenges multiply as these processes demand access to highly sensitive and specific datasets. Without a robust mechanism to define and enforce precise data access controls, organizations face the risk of exposing non-essential information. The absence of immutable logging and secure data sharing mechanisms further hampers the ability to establish accountability during audits or dispute resolution. Additionally, regulatory bodies often require data handling and cryptographic standards that traditional systems struggle to meet, adding another layer of complexity.

The inherent lack of user autonomy in identity management represents yet another drawback in existing systems. When third-party entities are entirely reliant on centralized repositories for their identity and credential management, they lose the ability to independently manage or update their data. This dependency not only restricts operational flexibility but also increases the risk of identity compromise in the event of a breach. Moreover, centralized systems often fail to scale effectively as the number of third-party interactions grows, resulting in bottlenecks and system inefficiencies.

Historical access control systems also lack effective logging mechanisms to provide comprehensive audit trails of third-party interactions with internal systems. Such shortcomings result in inadequate traceability and transparency, complicating efforts to identify and mitigate potential breaches. Organizations are unable to track the lifecycle of access permissions or verify compliance with predefined rules, leaving critical gaps in governance and oversight.

The financial implications of managing and maintaining existing systems are non-trivial. The need for additional resources, extensive monitoring teams, and recurring audits strains organizational budgets, diverting funds from innovation and operational priorities. Furthermore, the lack of automation in access control workflows leads to unnecessary delays and operational inefficiencies, adversely affecting productivity and customer satisfaction.

Existing solutions also lack adaptability to evolving technological landscapes. As the digital ecosystem grows more complex, organizations increasingly rely on advanced technologies such as API integrations and secure data sharing. However, traditional systems fail to provide the necessary flexibility and resilience to support these advancements, limiting their applicability in modern scenarios. Moreover, the rapid proliferation of digital entities exacerbates the limitations of centralized identity systems, highlighting the need for a decentralized and scalable approach.

One of the most pressing unmet needs in this domain is a system that empowers third parties to self-manage their identities while maintaining robust security and trust mechanisms. Despite the availability of fragmented solutions, none adequately address the need for a transparent, scalable, and decentralized framework that can ensure accountability without compromising operational efficiency. There is a long-felt need for a system that leverages cutting-edge technologies like distributed ledgers, cryptographic verifications, and decentralized identity management to bridge this critical gap, ensuring secure and seamless interactions across all stakeholders. This invention addresses this unmet need by introducing a revolutionary paradigm in identity and access management, setting a new standard for security, scalability, and operational excellence.

### SUMMARY OF THE INVENTION

The invention provides a transformative approach to managing third-party identities and access through a highly decentralized and secure framework. At its core, the system integrates advanced technologies such as blockchain, decentralized identifiers (DIDs), verifiable credentials (VCs), and public key cryptography. This integration establishes a robust, scalable, and tamper-proof ecosystem for identity management. By decentralizing the creation, storage, and verification of digital identities, the system ensures that each entity has full ownership and control over its identity, eliminating dependencies on centralized authorities and mitigating risks such as data breaches, unauthorized access, and operational inefficiencies. This design is particularly suited for industries like banking, finance, and regulatory bodies, where the security of sensitive data and trust in identity validation processes are paramount.

Decentralized identifiers (DIDs) are a cornerstone of the system, enabling third-party entities to generate unique, self-owned identities. These DIDs are cryptographically secure and stored on a blockchain, ensuring they are immutable and verifiable. Unlike traditional identity systems that rely on centralized repositories, DIDs empower entities to independently manage their identities without interference or oversight from external parties. Each DID is associated with critical information such as public keys and service endpoints, facilitating secure and efficient interactions between the identity owner and other systems. The resolution of DIDs to DID documents allows for seamless retrieval of identity-related data, further enhancing interoperability and functionality across diverse systems.

The invention also incorporates verifiable credentials (VCs), which are cryptographically signed certificates issued by trusted authorities such as banks or regulatory bodies. These credentials encode specific attributes, roles, or permissions granted to a third-party entity, forming a secure and trustworthy mechanism for defining and validating access rights. VCs are stored on a blockchain alongside their corresponding issuer's public key, ensuring they remain tamper-proof and verifiable. When an entity seeks access to a system, it presents its DID and the associated VC for validation. The verification process involves cross-referencing the credential with the issuer's public key on the blockchain, ensuring the integrity and authenticity of the information. This decentralized verification mechanism enhances trust, security, and transparency in identity management.

Public key cryptography underpins the entire system, providing a secure foundation for identity verification and access control. Each DID is linked to a pair of public and private keys, which are used for encryption, decryption, and digital signatures. This ensures that communications and transactions involving third-party entities are protected against interception and tampering. The integration of public key infrastructure (PKI) with blockchain technology creates a synergistic effect, enhancing the security and scalability of the identity management framework. The use of cryptographic methods also supports advanced features such as non-repudiation, ensuring that entities cannot deny actions performed using their private keys.

The blockchain's immutable ledger is a critical feature of the system, serving as a permanent and transparent record of all identity-related transactions. This ledger guarantees that all modifications, updates, and access attempts are securely logged and auditable. The immutability of the ledger ensures that historical data remains intact and verifiable, providing a reliable basis for compliance audits, dispute resolution, and forensic analysis. The system's reliance on blockchain technology eliminates the risks associated with data manipulation, ensuring the highest levels of integrity and trustworthiness in identity management processes.

The system emphasizes user control by allowing third-party entities to independently manage their identities and credentials. This approach eliminates reliance on centralized repositories, reducing vulnerabilities and operational overheads. Entities have the freedom to update or revoke credentials, modify personal information, and define access preferences without requiring external approval. The system automatically records these changes on the blockchain, maintaining a secure and transparent record of all identity management activities. This self-sovereign identity model empowers entities to retain ownership of their data, enhancing privacy and reducing the risks associated with centralized identity management systems.

The decentralized architecture of the system ensures distributed trust, a key advantage over traditional centralized models. By distributing identity data across multiple nodes in a blockchain network, the system enhances resilience against attacks, outages, and data loss. No single entity has control over the entire process, reducing the likelihood of systemic vulnerabilities. This distributed nature also fosters interoperability, enabling seamless integration with various systems and platforms. The use of standardized protocols for DIDs and VCs further enhances compatibility, ensuring that the system can adapt to diverse operational requirements and technological landscapes.

An integrated API gateway plays a crucial role in the system, facilitating secure and efficient interactions between third-party entities and internal systems. The gateway acts as a checkpoint, verifying DIDs and VCs before granting access to resources. This verification process ensures that only authorized entities can access specific systems, data, or functionalities. The API gateway also enforces granular access control policies based on the attributes defined in VCs, such as roles, permissions, and temporal limitations. This fine-grained control enhances security and flexibility, particularly in scenarios involving sensitive data or dynamic access requirements.

Temporal access controls are another innovative feature of the system, allowing credentials to be issued with specific time-based restrictions. These controls ensure that entities can only access resources for a predefined duration, reducing the risk of unauthorized access. Temporal limitations are particularly valuable in use cases such as regulatory audits, where access needs are temporary and strictly scoped. The system enforces these limitations through cryptographic time-stamping and blockchain-based logging, ensuring accountability and compliance with predefined access policies.

The invention accommodates both human and non-human users, providing a versatile solution for a wide range of applications. For human users, the system supports secure authentication mechanisms, session management, and role-based access control. For non-human users, such as automated processes or software agents, the system provides secure methods for presenting and verifying credentials, enabling seamless API-based interactions. This dual capability ensures that the system can meet the diverse identity management needs of modern digital ecosystems.

Granular data access controls are another standout feature, enabling organizations to define precise rules for accessing specific datasets or resources. These controls ensure that third-party entities can only interact with the data they are authorized to access, enhancing security and compliance. The system's ability to restrict access based on document types, data fields, or operational roles adds an additional layer of protection, making it an ideal solution for complex environments with stringent data governance requirements.

The system's logging and audit capabilities provide unparalleled transparency and accountability. All interactions, access attempts, and identity management activities are recorded on the blockchain, creating a comprehensive audit trail. This feature simplifies regulatory compliance by ensuring that all actions are traceable and verifiable. The audit trail is also invaluable for forensic investigations, enabling organizations to quickly identify and address unauthorized activities or security breaches.

Interoperability is a core strength of the invention, ensuring seamless integration with existing identity management systems and platforms. By adhering to standardized protocols for DIDs and VCs, the system facilitates compatibility with a wide range of applications and services. This interoperability makes the system highly adaptable, enabling it to meet the evolving needs of industries such as banking and government.

By decentralizing identity management and leveraging cutting-edge technologies such as blockchain and cryptography, the invention establishes a new standard for security, trust, and efficiency. Its innovative features, including self-owned identities, verifiable credentials, immutable logging, and distributed trust, make it a groundbreaking solution for addressing the challenges of modern identity and access management. This system represents a paradigm shift, empowering organizations and third-party entities to interact securely and transparently in an increasingly digital world.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for decentralized identity management and access control comprises generating, by a third-party entity, a decentralized identifier (DID) that is unique to the entity. The generation of the DID involves the use of a cryptographic key pair, ensuring that the identifier is secure and resistant to tampering. The DID includes associated metadata, such as public keys, service endpoints, and cryptographic checksums, which provide additional layers of security and facilitate interoperability with external systems. This identifier serves as a self-sovereign identity that is owned and managed by the third-party entity. Once the DID is generated, the blockchain network stores it on a distributed ledger, ensuring that the data is immutable and tamper-proof. The storage process involves verifying the integrity of the DID and its metadata using the cryptographic checksum before committing the information to the blockchain. The distributed ledger is designed to be permissioned, allowing only authorized participants to contribute to or access the data, ensuring a secure and controlled environment.

The method further comprises the issuance of a verifiable credential (VC) by a trusted authority. This credential is cryptographically signed using the trusted authority's private key and encodes critical information, including attributes, roles, permissions, expiration dates, temporal constraints, and data usage policies. The VC establishes the third-party entity's permissions and the scope of its access to specific resources. The trusted authority includes additional metadata in the VC, such as conditions for usage and access hierarchies, to provide granular control over access permissions. The issued VC is stored on the blockchain alongside the trusted authority's public key, ensuring that the credential is both tamper-proof and verifiable. The blockchain also records a cryptographic timestamp, providing a clear indication of when the credential was issued, and enabling the enforcement of temporal constraints encoded within the VC.

To access a resource, the third-party entity presents its DID and the associated VC to an API gateway. The presentation process involves demonstrating proof of possession of the associated private key to confirm the entity's control over the DID. The API gateway verifies the authenticity of the DID and VC by validating their cryptographic signatures against the public keys stored on the blockchain. This verification process ensures that the credential has not been altered and that it originates from a trusted authority. Additionally, the API gateway may employ a zero-knowledge proof protocol to validate claims made in the VC without revealing sensitive information, enhancing the privacy of the third-party entity.

Once the DID and VC are verified, the API gateway determines access permissions for the third-party entity. This involves evaluating the roles, attributes, and constraints encoded in the VC, such as specific actions the entity is authorized to perform, the data it is permitted to access, and any time-based restrictions. Temporal constraints are validated by comparing cryptographic timestamps against the current time, ensuring that access is granted only within the allowed timeframe. The API gateway cross-references the permissions with predefined resource access policies to determine whether the entity's request aligns with the security and operational requirements of the system.

The API gateway enforces multi-factor authentication as an additional security measure before granting access. This may involve combining VC-based identity verification with other authentication factors, such as one-time passwords, biometric verification, or device-based authentication. By incorporating multiple layers of verification, the system reduces the risk of unauthorized access and enhances overall security. If the verification process is successful and the entity's permissions align with the resource access policy, the API gateway grants access to the requested resource. The granted access is tailored to the specific permissions and constraints defined in the VC, ensuring that the third-party entity interacts only with the data or systems it is authorized to access.

The method includes recording the access transaction on the blockchain, creating an immutable audit trail. The recorded data includes the third-party entity's DID, the timestamp of access, the identifier of the accessed resource, and cryptographic hash values of the transaction data. This ensures that all access activities are logged transparently and securely while preserving the confidentiality of the data. The audit trail supports regulatory compliance and provides a reliable basis for forensic investigations and anomaly detection.

The method also enables the third-party entity to manage its DID and VC independently. This includes generating new cryptographic key pairs, linking the new keys to the existing DID, and updating associated metadata such as service endpoints. All updates are recorded on the blockchain as transactions, ensuring that the identity remains continuous and verifiable. The trusted authority retains the ability to revoke the VC if necessary, such as in cases of credential expiration, security concerns, or policy changes. Revocations are recorded on the blockchain as transactions, invalidating the credential while preserving its historical record for audit purposes.

The method incorporates a decentralized identity resolver, which queries the blockchain network to retrieve DIDs, associated metadata, VCs, and any updates or revocation records. This resolver provides verified and consistent identity data to authorized requesters while maintaining privacy. The system supports role-based access control policies, encoded within the VC, to define detailed permissions for actions the third-party entity is authorized to perform on the requested resource. This ensures fine-grained control over access, aligning with organizational policies and regulatory requirements.

To accommodate evolving operational needs, the method includes a dynamic policy update mechanism. This allows authorized administrators to modify access control policies stored on the blockchain without invalidating existing credentials or disrupting ongoing transactions. The updated policies are immediately enforceable, ensuring that the system remains flexible and responsive to changing security requirements. The method also integrates cross-platform compatibility to support interoperability with multiple blockchain networks and identity standards, enabling seamless verification of DIDs and VCs issued by diverse trusted authorities.

Finally, the method includes automated reconciliation of access logs and identity transactions across blockchain nodes. This supports compliance reporting, identifies anomalies in real-time, and resolves disputes related to third-party access and identity management. By combining advanced cryptographic methods, blockchain-based immutability, and decentralized identity frameworks, the method offers a comprehensive solution for secure, efficient, and scalable identity and access management.

In some arrangements, the method further comprises the decentralized identifier including a cryptographic checksum generated at the time of creation. This checksum is a cryptographic hash derived from the identifier and its associated metadata, ensuring that any alteration or corruption of the data can be immediately detected. The cryptographic checksum is validated by the blockchain network before the DID is committed to the distributed ledger, ensuring that only verified, unaltered data is stored. This validation process occurs during both the initial DID registration and any subsequent queries or updates, reinforcing the security of the identity management system. The checksum also facilitates cross-network integrity checks, enabling interoperability and consistency across multiple blockchain systems. By embedding a checksum, the method provides an added layer of integrity verification, ensuring that the stored data remains consistent and trustworthy throughout its lifecycle.

In some arrangements, the method further comprises using elliptic curve cryptography (ECC) to generate the cryptographic key pair for the decentralized identifier. ECC is selected for its high security-to-key-size ratio, which ensures robust cryptographic protection while minimizing computational overhead. The elliptic curve algorithms enable efficient key generation and verification processes, making the method well-suited for resource-constrained environments such as mobile devices or edge computing systems. The use of ECC also provides compatibility with modern cryptographic standards and supports enhanced encryption protocols. By employing ECC, the method enhances the robustness and efficiency of the identity management system, reducing vulnerabilities to cryptographic attacks while maintaining performance in distributed, high-volume identity systems.

In some arrangements, the method further comprises implementing the blockchain network as a permissioned blockchain to enhance security and governance. The permissioned blockchain limits participation to authorized entities, such as regulatory bodies, trusted organizations, and service providers, who adhere to predefined governance rules. These rules dictate participant roles, data access permissions, consensus protocols, and dispute resolution mechanisms, ensuring a controlled and transparent environment for storing and validating decentralized identifiers and verifiable credentials. The permissioned nature of the blockchain ensures that sensitive identity data is not exposed to unauthorized users while enabling traceability and accountability for all network transactions. This setup also allows for customized configurations, such as integrating industry-specific standards or regulatory requirements, further enhancing the blockchain network's applicability to diverse use cases.

In some arrangements, the method further comprises the trusted authority including additional metadata in the verifiable credential to define granular access control. The metadata may include expiration dates, hierarchical roles, scope of access permissions, and data usage policies, providing a comprehensive framework for defining and managing access rights. These attributes are encoded cryptographically within the VC, ensuring that they cannot be altered without detection. The inclusion of such metadata allows the system to support complex access scenarios, such as restricting access to specific data fields, limiting usage to certain operations, or enabling conditional access based on environmental factors. This granularity enhances the system's adaptability to a wide range of organizational and regulatory requirements.

In some arrangements, the method further comprises encoding temporal constraints directly within the verifiable credential. These constraints specify the time periods during which the credential is valid, allowing the system to enforce strict time-based access policies. The temporal constraints are tied to cryptographic timestamps issued during the credential generation process, ensuring that the validity period cannot be manipulated. The system verifies the temporal constraints by comparing the cryptographic timestamp with the current time during access requests, ensuring that expired credentials are automatically invalidated. This feature is particularly valuable for time-sensitive applications, such as regulatory audits, project-based collaborations, or temporary access scenarios, where access must be precisely controlled and monitored.

In some arrangements, the method further comprises the API gateway employing a zero-knowledge proof protocol during the verification process to preserve the privacy of the third-party entity. This protocol allows the API gateway to validate specific claims encoded in the verifiable credential, such as the entity's role or permission level, without requiring the full disclosure of sensitive information. The zero-knowledge proof enhances the confidentiality of the verification process, ensuring that sensitive data remains protected even during cross-system interactions. This capability is particularly beneficial for applications where data privacy and compliance with regulations, such as GDPR or HIPAA, are critical.

In some arrangements, the method further comprises the API gateway interfacing with multiple blockchain networks to support the validation of decentralized identifiers and verifiable credentials issued by diverse trusted authorities. This interoperability ensures that third-party entities can seamlessly interact with multiple systems and platforms, regardless of the underlying blockchain architecture. The API gateway leverages standardized protocols for cross-chain communication, enabling consistent identity verification across heterogeneous blockchain ecosystems. This capability broadens the system's applicability, making it suitable for global, multi-industry deployments.

In some arrangements, the method further comprises enforcing multi-factor authentication for the third-party entity at the API gateway before granting access to the requested resource. The multi-factor authentication process combines verifiable credential-based identity verification with additional authentication mechanisms, such as biometric scans, hardware tokens, or one-time passwords. These additional factors enhance the security of the access control process by mitigating the risk of credential theft or compromise. The multi-factor authentication framework is adaptable, allowing the system to dynamically adjust authentication requirements based on the sensitivity of the requested resource or the risk profile of the entity.

In some arrangements, the method further comprises recording cryptographic hash values of the accessed data as part of the access transaction log. These hash values provide a secure, tamper-proof representation of the data without exposing its content, ensuring that sensitive information remains confidential. The cryptographic hash is stored on the blockchain alongside other transaction details, such as the third-party entity's decentralized identifier, the timestamp of access, and the identifier of the accessed resource. This comprehensive logging ensures a reliable and immutable audit trail, supporting compliance with regulatory requirements and enabling forensic investigations when necessary.

In some arrangements, the method further comprises enabling the third-party entity to update its decentralized identifier metadata by generating a new cryptographic key pair. The new keys are securely linked to the existing DID through a blockchain transaction, ensuring that the identity remains continuous and verifiable. This capability allows entities to adapt to changing security requirements, such as replacing compromised keys or updating service endpoints, while maintaining the integrity of their identity.

In some arrangements, the method further comprises the trusted authority revoking the verifiable credential when required, such as in cases of expiration, policy changes, or detected security breaches. The revocation is recorded as a blockchain transaction, which invalidates the credential while preserving its historical record. This mechanism ensures that unauthorized or outdated credentials cannot be used to access resources, enhancing the system's responsiveness to dynamic security threats.

In some arrangements, the method further comprises a decentralized identity resolver querying the blockchain network to retrieve the decentralized identifier, associated metadata, verifiable credentials, and any update or revocation records. The resolver provides verified and consistent identity data to authorized entities while maintaining compliance with privacy and data protection standards. This feature simplifies identity verification across distributed systems, enabling seamless and secure interactions.

In some arrangements, the method further comprises encoding a role-based access control mechanism within the verifiable credential. This mechanism defines specific actions the third-party entity is authorized to perform on the requested resource, such as viewing, editing, or deleting data. The system enforces these controls by evaluating the encoded permissions during access requests, ensuring that entities can only perform actions explicitly allowed by their roles.

In some arrangements, the method further comprises implementing a dynamic policy update mechanism that enables authorized administrators to modify access control policies stored on the blockchain. These updates may include changes to roles, permissions, temporal constraints, or resource hierarchies and are enforced without invalidating existing credentials or disrupting ongoing transactions. The dynamic policy framework ensures that the system remains flexible and adaptable to evolving organizational and regulatory requirements.

In some arrangements, the method further comprises integrating cross-platform compatibility to enable seamless interoperability with diverse blockchain networks and identity standards. The method also includes automated reconciliation of access logs and identity transactions across blockchain nodes, supporting compliance reporting, real-time anomaly detection, and the resolution of disputes related to third-party access. These features enhance the scalability, transparency, and reliability of the identity management system, making it a comprehensive solution for secure and efficient access control in complex digital ecosystems.

In some arrangements, a system for decentralized identity management and access control comprises a collection of integrated components designed to provide secure, efficient, and scalable identity verification and resource access. At the core of the system is a decentralized identifier generator that enables third-party entities to create unique identifiers using cryptographic key pairs. These decentralized identifiers, or DIDs, are enriched with associated metadata, including public keys, service endpoints, and cryptographic checksums, ensuring robust data integrity and the ability to interact seamlessly with external systems. The DID generator employs advanced cryptographic techniques, such as elliptic curve cryptography, to produce secure and computationally efficient key pairs, making the system well-suited for resource-constrained environments such as mobile devices and edge computing platforms. The DID serves as a self-sovereign identity, granting third-party entities full control over their identifiers while maintaining compatibility with global identity standards.

The system includes a blockchain network that serves as a tamper-proof and immutable ledger for storing DIDs and their associated metadata. This blockchain network is implemented as a permissioned blockchain, limiting participation to trusted entities such as regulatory bodies, financial institutions, and service providers. These participants adhere to predefined governance rules that establish roles, data access permissions, and consensus protocols, ensuring a secure and controlled environment for identity management. The blockchain network verifies the integrity of DIDs and their metadata before committing them to the ledger, using cryptographic checksums to detect any unauthorized modifications. This process ensures that only verified and unaltered data is stored, providing a trustworthy foundation for decentralized identity operations. The blockchain also supports interoperability with multiple identity ecosystems by adhering to standardized protocols, enabling seamless interactions across different blockchain platforms.

A trusted authority module within the system is responsible for issuing verifiable credentials to third-party entities. These credentials are cryptographically signed using the private key of the trusted authority and encode detailed information about the entity's attributes, roles, permissions, expiration dates, temporal constraints, and data usage policies. The trusted authority can include additional metadata, such as access hierarchies and conditional constraints, to provide granular control over resource access. Each verifiable credential is securely stored on the blockchain alongside the trusted authority's public key and a cryptographic timestamp, creating an immutable and verifiable record. The system ensures that these credentials remain tamper-proof while supporting dynamic updates and revocations as required by operational or security considerations.

The system incorporates an API gateway that acts as the central interface for third-party entities requesting access to resources. The API gateway is designed to verify the authenticity of DIDs and their associated verifiable credentials by validating cryptographic signatures against the public keys stored on the blockchain. This verification process ensures that the credentials originate from a trusted authority and have not been altered. To enhance privacy, the API gateway can employ zero-knowledge proof protocols, which allow it to confirm specific claims encoded in the verifiable credentials without exposing sensitive details. This capability is particularly important for applications requiring compliance with data protection regulations, such as GDPR or HIPAA, where maintaining confidentiality is paramount.

An access control engine within the system evaluates the permissions and constraints encoded in the verifiable credentials to determine whether access should be granted to the requested resource. This engine examines roles, temporal limitations, and resource-specific access rights, ensuring that each access request aligns with predefined security policies. Temporal constraints are enforced by comparing cryptographic timestamps with the current system time, ensuring that credentials are only valid within their specified timeframes. This granular and dynamic access control capability enables the system to adapt to a wide range of operational scenarios, including time-sensitive collaborations and regulatory audits.

To further enhance security, the system includes a multi-factor authentication module integrated with the API gateway. This module enforces additional authentication requirements, such as biometric verification, hardware tokens, or one-time passwords, before granting access to resources. The multi-factor authentication process is adaptable, allowing the system to dynamically adjust the level of security based on contextual risk factors, such as the sensitivity of the requested resource or the geolocation of the requesting entity. This layered security approach reduces the risk of unauthorized access and ensures the integrity of critical systems.

The system also includes a transaction logging module that records all access events on the blockchain, creating an immutable audit trail. Each log entry includes the third-party entity's decentralized identifier, the timestamp of the access event, the identifier of the accessed resource, and cryptographic hash values of the transaction data. These hash values ensure that sensitive data remains confidential while providing a verifiable representation of the accessed information. The audit trail supports compliance with regulatory requirements, enables forensic investigations, and facilitates anomaly detection by providing a transparent and tamper-proof record of all access activities.

A decentralized identity resolver is integrated into the system to query the blockchain network and retrieve DIDs, verifiable credentials, and any associated updates or revocation records. This resolver ensures that authorized entities can access verified and consistent identity data across distributed systems, simplifying cross-platform identity verification. The system also includes a role-based access policy manager that encodes detailed access permissions within the verifiable credentials. This manager defines specific actions that third-party entities are authorized to perform on requested resources, such as viewing, editing, or deleting data. The encoded policies are enforced by the access control engine, ensuring that resource access is tightly aligned with organizational policies and regulatory requirements.

The system features a dynamic policy update module that allows authorized administrators to modify access control policies stored on the blockchain. These updates can include changes to roles, permissions, temporal constraints, or resource hierarchies and are enforced without invalidating existing credentials or disrupting ongoing transactions. This capability ensures that the system remains flexible and responsive to evolving security and operational needs. Additionally, the system supports cross-platform compatibility, enabling it to interact seamlessly with multiple blockchain networks and identity standards. This interoperability broadens the system's applicability, making it suitable for global deployments across diverse industries.

To enhance operational efficiency, the system includes an automated reconciliation engine that analyzes access logs and identity transactions across blockchain nodes. This engine supports compliance reporting, real-time anomaly detection, and dispute resolution, providing actionable insights for administrators. By integrating these advanced features, the system offers a comprehensive and scalable solution for secure, transparent, and efficient identity management and access control, making it a transformative tool for modern digital ecosystems.

In some arrangements, the system is enhanced by implementing the blockchain network as a consortium blockchain, which operates under a well-defined governance framework to ensure both security and collaborative control. Participation in this blockchain is restricted to authorized entities such as regulatory bodies, financial institutions, government agencies, and identity verification providers, each playing a distinct role in the network's operations. The governance framework establishes clear rules regarding data access permissions, consensus protocols, and the resolution of disputes that may arise during network operations. These predefined rules are collaboratively managed by the consortium members, providing a balance between decentralization and control. By restricting participation to trusted parties, the consortium blockchain minimizes risks associated with unauthorized data access or tampering while maintaining transparency and accountability among members. The controlled nature of the blockchain also enables enhanced performance compared to public blockchains, as the limited number of participants reduces the computational overhead of achieving consensus. This structure is particularly suited for environments where trust, compliance, and high throughput are critical, such as financial transactions, data exchanges, and regulated digital ecosystems. The blockchain network also supports dynamic configuration to incorporate industry-specific standards, compliance frameworks, and interoperability protocols, ensuring its adaptability to diverse regulatory and operational requirements.

In some arrangements, the system incorporates an adaptive authentication mechanism within the API gateway, further enhancing its security and usability. This mechanism evaluates a range of contextual risk factors to dynamically adjust authentication requirements for each access request. These factors include the geolocation of the requesting entity, the device type being used, the historical access behavior of the entity, current network conditions, and the sensitivity of the resource being accessed. For example, if an access request originates from a previously unseen location or device, the system may require additional layers of authentication, such as biometric scans or hardware-based tokens, to confirm the legitimacy of the request. Conversely, if a request comes from a pre-approved device in a trusted environment, the system may allow a streamlined authentication process to reduce friction for the user. The adaptive authentication mechanism employs machine learning algorithms to continuously refine its risk assessment models based on new data, improving its ability to identify potential threats while minimizing false positives. This real-time adjustment ensures that the system can respond to evolving threat landscapes without compromising usability for legitimate users. The adaptive mechanism is particularly valuable in environments where security needs fluctuate based on contextual factors, such as financial systems processing high-value transactions or government systems handling classified data.

In some arrangements, the system further integrates an advanced anomaly detection system within the transaction logging module, leveraging artificial intelligence to analyze access events in real time. This anomaly detection system monitors every access transaction, comparing it against established behavioral baselines derived from historical data. It identifies deviations that may indicate unauthorized or suspicious activities, such as access requests originating from unexpected locations, unusually high-frequency access attempts, repeated failed authentication attempts, or attempts to access restricted resources. Upon detecting an anomaly, the system generates immediate alerts to notify system administrators of the potential threat. Additionally, the system can initiate automated mitigation measures to protect sensitive resources and maintain system integrity. These measures include temporarily suspending the access credentials associated with the anomalous activity, isolating the entity from critical resources, or triggering a blockchain-based workflow to revoke the compromised credential. The anomaly detection system continuously updates its detection algorithms using machine learning techniques, enabling it to adapt to emerging threat patterns and reduce the likelihood of false positives. This proactive approach ensures that security incidents are identified and addressed before they can escalate, providing organizations with a robust defense against evolving cyber threats. The integration of real-time anomaly detection with automated response mechanisms enhances the resilience of the system, ensuring that sensitive resources remain secure even in high-risk operational environments. This capability is particularly critical for organizations managing high-value assets, handling sensitive data, or operating in industries that face constant and sophisticated cybersecurity challenges. By combining advanced analytics, machine learning, and automated threat response, the system offers unparalleled protection and operational continuity in dynamic and complex ecosystems.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a system architecture for decentralized identity management and access control, illustrating the integration of components such as the blockchain network, decentralized identifier generator, trusted authority module, API gateway, access control engine, and anomaly detection module. The figure shows the flow of data and interactions between these components, including the generation, validation, and enforcement of identity and access policies.

FIG. 2 depicts the architecture of a blockchain-enabled system for decentralized third-party identity management, highlighting components such as Decentralized Identifiers (DIDs), Verifiable Credentials (VCs), and a Blockchain for Trust and Integrity. It illustrates the flow of processes, including DID generation and storage, VC issuance and verification, and access control integration via an API Gateway for secure and transparent interactions.

FIG. 3 depicts the process flow of a blockchain-enabled decentralized third-party identity management system, illustrating stages such as Identity Generation, DID Document Creation, Trustworthy Identification, Verifiable Credential Issuance, and Verifiable Credential Presentation. It also highlights the roles of Immutable Ledger creation and Distributed Trust validation to ensure secure, tamper-proof, and decentralized management of identity data.

FIG. 4 depicts a sequence diagram illustrating the interactions among the Third-Party Entity, Blockchain Network, Trusted Authority, API Gateway, and Resource System for decentralized identity management and access control. It showcases key processes such as generating and storing a decentralized identifier (DID), issuing and validating verifiable credentials (VCs), verifying identity, enforcing access permissions, and maintaining immutable audit trails through blockchain logging.

FIG. 5 depicts a class diagram illustrating the key components of a blockchain-enabled decentralized identity management system, including classes such as DecentralizedIdentifier, VerifiableCredential, Blockchain, APIGateway, Resource, User, and TrustedAuthority. The diagram highlights the attributes, methods, and interrelationships of these classes, showcasing how they collectively enable secure identity generation, credential management, access control, and immutable transaction logging.

### DETAILED DESCRIPTION

The invention provides a highly advanced, decentralized system for managing third-party identities and controlling access to sensitive resources. The system integrates state-of-the-art technologies, including blockchain, decentralized identifiers (DIDs), verifiable credentials (VCs), cryptographic methods, machine learning, and interoperability frameworks, to deliver a secure, scalable, and efficient identity management solution. It empowers third-party entities to self-manage their digital identities while implementing strong security protocols to prevent unauthorized access and ensure data integrity. By decentralizing control, the system mitigates risks associated with centralized vulnerabilities, such as single points of failure, and establishes trust among multiple stakeholders.

At the foundation of the system is the decentralized identifier generator, which allows third-party entities to create unique DIDs using cryptographic key pairs. These identifiers include associated metadata, such as public keys, service endpoints, and cryptographic checksums, ensuring data integrity and seamless interoperability with other systems. The use of elliptic curve cryptography (ECC) for key generation provides robust security and computational efficiency, making the system adaptable for devices with limited resources, such as mobile phones or IoT devices. The identifiers are self-sovereign, granting full control to the entity while aligning with global standards for decentralized identity systems.

The DIDs, along with their metadata, are securely stored on a blockchain network that serves as an immutable distributed ledger. The blockchain is implemented as a permissioned network, where participation is restricted to authorized entities, including regulatory bodies, financial institutions, and trusted organizations. These participants adhere to predefined governance rules that regulate data access permissions, consensus protocols, and dispute resolution mechanisms. The blockchain validates the integrity of all data before committing it to the ledger, using cryptographic checksums to detect tampering or unauthorized modifications. This controlled environment ensures a balance between decentralization and security, making the blockchain suitable for regulated industries such as finance and government.

The trusted authority module within the system is responsible for issuing verifiable credentials to third-party entities. These credentials cryptographically encode a range of attributes, roles, permissions, expiration dates, temporal constraints, and data usage policies, defining the scope and conditions of access. Each VC is signed using the trusted authority's private key to ensure its authenticity and integrity. Additional metadata, such as hierarchical access controls and conditional policies, can be embedded within the credential to enable granular control. Once issued, the VC is stored on the blockchain, alongside the trusted authority's public key and cryptographic timestamps, creating a tamper-proof record that supports real-time validation and revocation.

The system's API gateway acts as the main interface for third-party entities to request access to resources. The gateway verifies the authenticity of the DID and associated VC by validating their cryptographic signatures against the public keys stored on the blockchain. To enhance privacy, the API gateway can employ zero-knowledge proof protocols, allowing it to confirm specific claims encoded in the VC without revealing sensitive information. This capability is essential for complying with stringent data protection regulations, such as GDPR or HIPAA, which mandate the confidentiality of personal and sensitive data.

Access control is enforced through an integrated engine that evaluates permissions and constraints encoded in the VC. The engine determines whether the access request aligns with predefined policies, considering roles, attributes, and contextual factors such as the requested resource's sensitivity. Temporal constraints are enforced by comparing cryptographic timestamps against the current system time, ensuring that access is granted only within the allowable timeframe. This level of granularity ensures precise control over resource access and aligns with organizational security requirements.

The system also includes a multi-factor authentication module integrated with the API gateway. This module enforces additional security measures, such as biometric verification, one-time passwords, or hardware tokens, before granting resource access. The multi-factor framework is adaptive, allowing the system to dynamically adjust authentication requirements based on contextual risk factors, such as the geographic location of the request, device type, or access history. High-risk scenarios may trigger stricter authentication protocols, while low-risk interactions can proceed with simplified processes to enhance user experience.

To ensure transparency and accountability, the system incorporates a transaction logging module that records all access events on the blockchain. Each transaction log includes the third-party entity's DID, the timestamp of access, the identifier of the accessed resource, and cryptographic hash values of the transaction data. These logs are immutable and provide a reliable audit trail for regulatory compliance, forensic investigations, and anomaly detection. By storing cryptographic hashes rather than raw data, the system ensures confidentiality while maintaining verifiability.

A decentralized identity resolver is integrated into the system to query the blockchain network for DIDs, VCs, and any associated updates or revocation records. This resolver provides verified and consistent identity data to authorized entities, supporting seamless identity verification across distributed systems. It also ensures cross-platform compatibility, enabling the system to operate across multiple blockchain networks and adhere to various identity standards.

Role-based access control policies are encoded within the VCs, specifying the actions third-party entities are authorized to perform. These policies are enforced by the access control engine, ensuring that entities can interact only with the data or systems explicitly permitted by their credentials. This fine-grained access management capability enhances security and ensures compliance with organizational policies and regulatory frameworks.

The system includes a dynamic policy update module that allows authorized administrators to modify access control policies stored on the blockchain. These updates can include changes to roles, permissions, temporal constraints, or resource hierarchies and are implemented without invalidating existing credentials or disrupting ongoing transactions. This flexibility enables the system to adapt to evolving security and operational needs while maintaining continuity.

To address real-time threats, the system integrates an anomaly detection module powered by artificial intelligence. This module continuously monitors access events, comparing them against behavioral baselines to identify deviations that may indicate unauthorized activity. When anomalies such as unusual login attempts, access from unfamiliar locations, or repeated failed authentication attempts are detected, the system generates alerts and initiates automated mitigation measures. These measures may include suspending credentials, isolating compromised entities, or triggering a blockchain-based revocation workflow.

The system supports automated reconciliation of access logs and identity transactions across blockchain nodes to ensure data consistency. This reconciliation process is powered by machine learning algorithms that identify discrepancies, generate compliance reports, and provide actionable insights to administrators. These capabilities simplify regulatory reporting and enhance trust among stakeholders by ensuring a consistent and transparent record of all activities.

Self-management of DIDs and VCs is another key feature of the system. Third-party entities can update their metadata, generate new cryptographic keys, or revoke credentials as needed. All changes are securely logged on the blockchain, ensuring the continuity and traceability of the identity. This self-sovereign identity model empowers entities to maintain control over their data while leveraging the security and trust provided by the blockchain.

The system also allows trusted authorities to revoke VCs when necessary, such as in cases of expiration, policy changes, or detected security breaches. Revocation events are recorded on the blockchain, ensuring that the revoked credentials are immediately invalidated while preserving their historical record for audit purposes.

The consortium blockchain architecture operates under a collaborative governance model, with participants collectively managing the network. Governance rules define data access permissions, consensus protocols, and operational policies, ensuring security and transparency. This structure also supports industry-specific compliance requirements, making the system adaptable to diverse regulatory and operational contexts.

By integrating blockchain immutability, advanced cryptographic methods, dynamic policy updates, and machine learning-powered anomaly detection, the invention delivers a comprehensive solution for secure, scalable, and efficient identity management. It addresses the challenges of trust, privacy, and interoperability, establishing a robust framework for managing digital identities in modern, complex ecosystems. The system's adaptability ensures its relevance across various industries, providing a future-proof approach to identity and access management.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

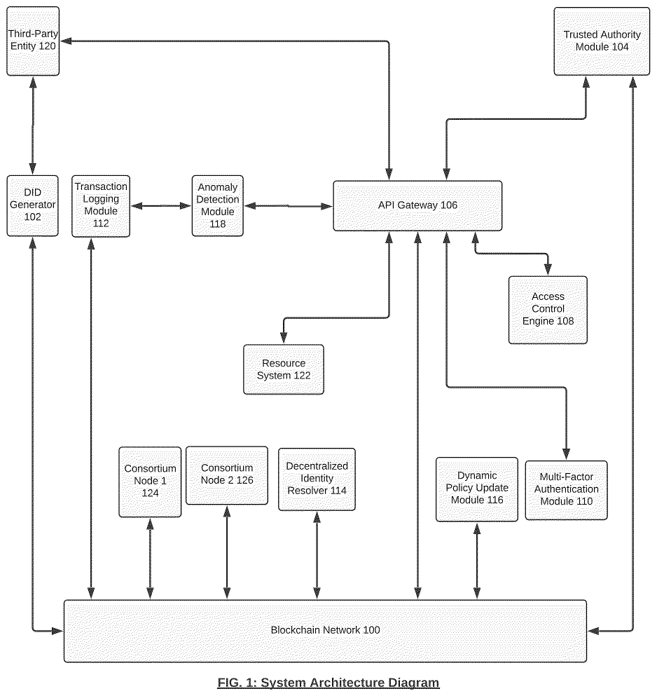

FIG. 1 depicts the comprehensive architecture of a blockchain-based decentralized identity management and access control system, showcasing its core components and their intricate interactions. At the center of the system is the Blockchain Network 100, which acts as the backbone for storing and validating decentralized identifiers (DIDs), verifiable credentials (VCs), and transaction logs. This blockchain is implemented as a permissioned network, ensuring that only authorized entities, such as Consortium Node 1(124 ) and Consortium Node 2 (126), participate in the consensus mechanism. The consortium nodes collaboratively maintain the integrity of the network, enforce governance policies, and handle dispute resolution. The Blockchain Network 100 is designed to provide an immutable ledger where all transactions, including the creation, validation, and revocation of credentials, are permanently and securely recorded.

To the left of the Blockchain Network 100, the DID Generator 102 is responsible for enabling third-party entities, represented by Third-Party Entity 120, to generate unique decentralized identifiers. These identifiers are cryptographically secure and include metadata such as public keys, service endpoints, and cryptographic checksums to ensure data integrity and compatibility with external systems. The cryptographic key pairs, generated using elliptic curve cryptography, provide a high level of security while maintaining computational efficiency. Once generated, the DID and its metadata are transmitted to the Blockchain Network 100, where they are validated and stored. The cryptographic checksum ensures that any modifications to the data can be detected immediately, preserving the integrity of the system.

The Trusted Authority Module 104 is depicted adjacent to the DID Generator 102 and plays a critical role in the issuance of verifiable credentials. This module interacts with third-party entities to encode specific attributes, roles, permissions, expiration dates, and temporal constraints into the credentials. Each verifiable credential is cryptographically signed using the private key of the trusted authority, guaranteeing its authenticity and resistance to tampering. Additional metadata, such as access hierarchies and conditional access policies, can also be included to enable granular control. The Trusted Authority Module 104 ensures that the credentials are stored on the Blockchain Network 100 alongside cryptographic timestamps and the trusted authority's public key, facilitating real-time validation and the ability to revoke credentials as needed.

The API Gateway 106 is situated to the right of the Blockchain Network 100 and serves as the central interface for third-party entities requesting access to resources. This gateway is responsible for verifying the authenticity of the DIDs and VCs presented by the entities. By validating cryptographic signatures against the public keys stored on the blockchain, the API Gateway 106 ensures that credentials are legitimate and originate from trusted authorities. To enhance privacy, the API Gateway 106 can employ zero-knowledge proof protocols, enabling it to confirm specific claims in the credentials without exposing sensitive details. This feature is particularly valuable for applications requiring strict compliance with data protection regulations, such as GDPR or HIPAA.

The Access Control Engine 108, directly integrated with the API Gateway 106, evaluates access requests based on the permissions, roles, and contextual constraints encoded in the VCs. The engine considers factors such as temporal constraints, which are validated using cryptographic timestamps to ensure that access is only granted within the specified timeframe. This granular evaluation allows the system to enforce strict access policies tailored to organizational needs while preventing unauthorized resource interactions. The integration of the Access Control Engine 108 with the API Gateway 106 ensures seamless decision-making and enforcement of access policies.

The Multi-Factor Authentication Module 110 enhances the system's security by requiring additional verification steps before granting access. This module supports a variety of authentication methods, including biometric scans, one-time passwords, and hardware tokens. The adaptive nature of this module allows the system to dynamically adjust the level of authentication required based on contextual risk factors such as the sensitivity of the resource, the geographic location of the request, or the historical behavior of the entity. By layering multiple authentication mechanisms, the system minimizes the risk of unauthorized access while maintaining user convenience.

The Transaction Logging Module 112, positioned at the base of the Blockchain Network 100, records all access events in an immutable and transparent manner. Each log entry includes critical details such as the DID of the accessing entity, the timestamp of the transaction, the identifier of the accessed resource, and cryptographic hash values representing the data involved. By storing these logs on the blockchain, the system ensures that they are tamper-proof and verifiable, supporting compliance with regulatory standards and enabling forensic analysis in the event of a security incident.

To the left of the Blockchain Network 100, the Decentralized Identity Resolver 114 queries the ledger to retrieve DIDs, VCs, and associated records. This resolver ensures that identity data is consistently validated across distributed systems, enabling seamless interoperability with external applications. The Decentralized Identity Resolver 114 supports cross-platform compatibility, allowing the system to interact with multiple blockchain ecosystems and adhere to diverse identity standards.

The Dynamic Policy Update Module 116, located above the Blockchain Network 100, allows authorized administrators to modify access control policies stored on the blockchain without disrupting ongoing transactions or invalidating existing credentials. This module supports updates to roles, permissions, resource hierarchies, and temporal constraints, ensuring that the system remains adaptable to evolving security requirements and operational needs. Changes made through this module are immediately enforced across the system, maintaining the integrity of access controls.

The Anomaly Detection Module 118, connected to both the Transaction Logging Module 112 and the API Gateway 106, monitors access events in real time to identify suspicious activities. This module leverages artificial intelligence to analyze behavioral patterns and detect anomalies such as unusual login attempts, access from unfamiliar locations, or repeated failed authentication attempts. When anomalies are detected, the system triggers automated responses such as credential suspension, entity isolation, or the initiation of a revocation workflow on the blockchain.

On the far right of the architecture is the Resource System 122, representing the endpoint for access requests. Verified entities interact with the Resource System 122 through the API Gateway 106, ensuring that only authorized and authenticated users gain access to sensitive resources. The connection between the API Gateway 106 and the Resource System 122 highlights the seamless integration of the system's identity management framework with its operational endpoints.

The architecture in FIG. 1 encapsulates the complete functionality of the invention, demonstrating how decentralized identity management, blockchain immutability, advanced authentication methods, dynamic policy updates, and real-time anomaly detection are combined to provide a secure, scalable, and interoperable solution for modern identity and access management challenges. This detailed integration of components ensures that the system delivers robust security, user privacy, and operational efficiency across a wide range of applications and industries.

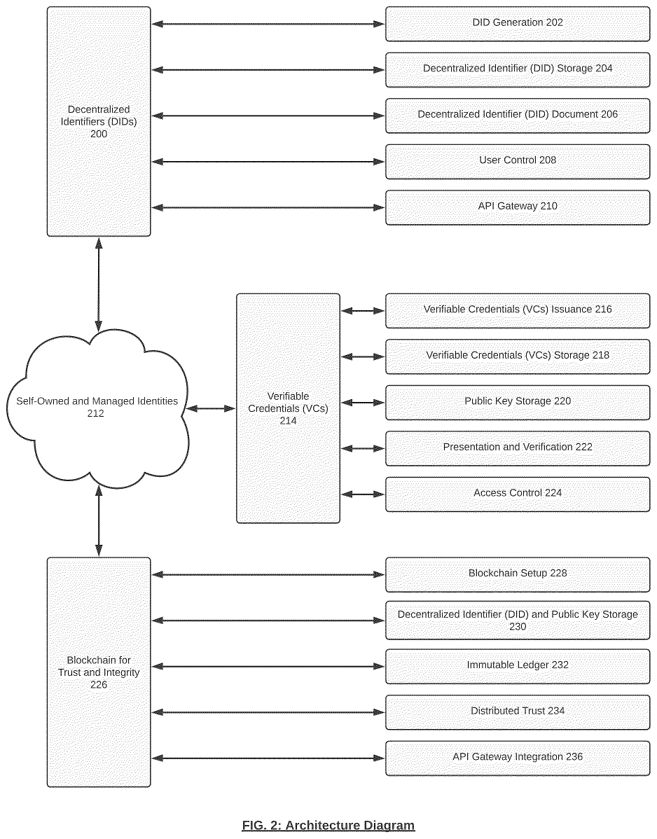

FIG. 2 illustrates a comprehensive architecture for a blockchain-enabled system designed to provide decentralized third-party identity management with a focus on secure and transparent access control. This system integrates advanced cryptographic mechanisms, distributed ledger technology, and decentralized identifiers to ensure robust security, operational efficiency, and user autonomy. At the center of the architecture is the concept of Decentralized Identifiers (DIDs), represented as 200, which are unique cryptographic identifiers generated by third-party entities to establish self-sovereign identities. The process of DID generation, marked as 202, utilizes cryptographic key pairs to ensure the uniqueness and security of the identifier, eliminating the dependency on central authorities. Once generated, these identifiers are securely stored in the blockchain network, as shown by 204, which provides an immutable and tamper-proof repository for identity data. The blockchain's decentralized nature ensures that no single entity can alter or compromise the integrity of the stored data, thereby fostering trust and resilience in the system.

The DIDs are further associated with a DID document, depicted as 206, which contains critical metadata, including public keys and service endpoints necessary for identity resolution and interoperability across diverse systems. The DID document enables entities to retrieve and verify identity information seamlessly, supporting interactions with multiple stakeholders in a secure manner. The component labeled as 208 represents user control, which is a cornerstone of the system. It empowers third-party entities to manage their identities autonomously, allowing them to update or revoke credentials without relying on centralized repositories. This autonomy is crucial for maintaining privacy and reducing risks associated with centralized data breaches.

The API Gateway, identified as 210, acts as a mediator and validation checkpoint between third-party entities and internal systems. It ensures that only verified and authorized entities can access sensitive resources, thereby strengthening the security posture of the system. The architecture further incorporates Verifiable Credentials (VCs), denoted as 214, which are cryptographically signed certificates issued by trusted authorities, such as banks or regulatory bodies. These credentials encode essential information such as attributes, permissions, and roles, which define the scope of access granted to third-party entities. The issuance of these credentials is managed through a process represented as 216, ensuring that they originate from credible and verified sources.

The Verifiable Credentials are securely stored on the blockchain, as indicated by 218, which guarantees their integrity and provides a reliable mechanism for verification. The system also includes public key storage, marked as 220, which maintains the public keys associated with DIDs and VCs. This component is critical for the verification process, as it allows the system to validate the authenticity of presented credentials against the issuer's public key stored on the blockchain. The presentation and verification module, labeled as 222, facilitates the use of these credentials by third-party entities to access internal systems. During this process, the system cross-references the credentials with the public keys and metadata stored on the blockchain to ensure their validity and authenticity.

Access control, denoted as 224, is a pivotal feature of the architecture, enabling the enforcement of granular permissions. It ensures that entities can only access resources and perform actions explicitly authorized by their credentials, thereby reducing the risk of unauthorized access and misuse. The blockchain itself serves as the backbone of the system, providing trust and integrity as represented by 226. It maintains an immutable ledger, depicted as 232, which records all transactions, updates, and interactions related to identity management. This ledger ensures transparency and auditability, making it an invaluable tool for compliance with regulatory requirements and for resolving disputes.

The distributed nature of the blockchain, illustrated by 234, ensures that identity data is not controlled by a single entity, thereby enhancing security and reducing the risks of centralized failures. The API Gateway's integration with the blockchain, represented as 236, facilitates seamless interaction between decentralized identity data and internal systems, ensuring efficient and secure access management. This architecture supports a distributed trust model, which is critical for modern digital ecosystems where multiple stakeholders require secure and trustworthy interactions.

Through its innovative design, FIG. 2 represents a transformative approach to identity management by decentralizing the processes of identity creation, storage, and verification. This system addresses longstanding challenges such as unauthorized access, data breaches, and operational inefficiencies by leveraging advanced technologies, including cryptographic methods and distributed ledgers. Each component in FIG. 2 contributes to a cohesive and secure framework, ensuring scalability, transparency, and adaptability for managing third-party identities across diverse industries. By integrating user control, verifiable credentials, and blockchain immutability, the system sets a new standard for secure and efficient identity and access management. This detailed description expands on the claims by highlighting the system's ability to generate unique decentralized identifiers, issue and verify cryptographically secured credentials, and maintain a transparent and immutable audit trail of identity-related activities.

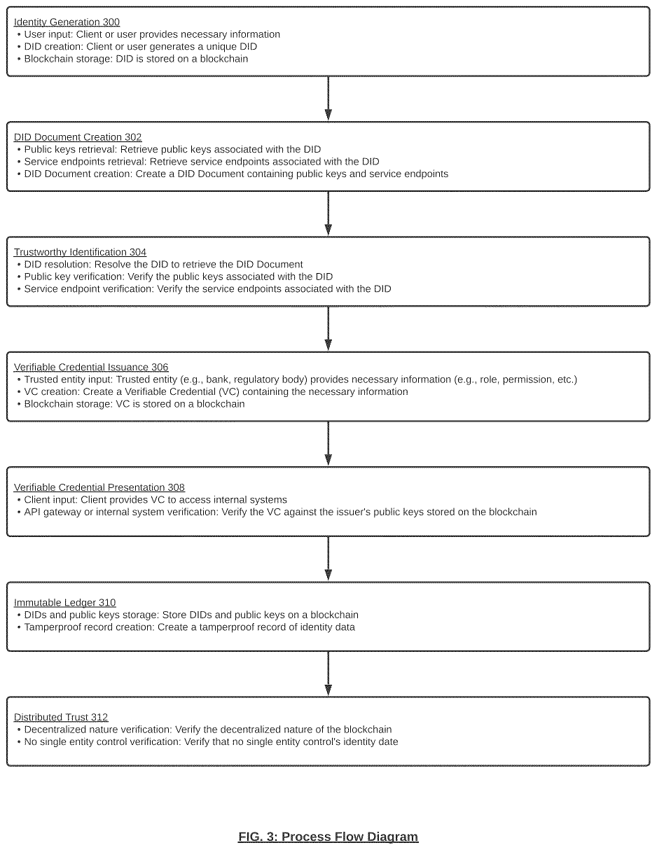

FIG. 3 provides a comprehensive visualization of the process flow for a blockchain-enabled system designed to manage decentralized third-party identities with unparalleled security, transparency, and operational efficiency. The diagram begins with the identity generation phase, marked as 300, where a user or client initiates the process by providing necessary information to create a decentralized identifier (DID). This DID is generated using advanced cryptographic algorithms to ensure its uniqueness, integrity, and resistance to tampering. The identifier acts as a cornerstone of the user's self-sovereign identity, empowering the user with complete ownership and control. Once generated, the DID is stored securely on a blockchain, leveraging the decentralized ledger's inherent immutability and tamper-resistance to safeguard identity data. This step is critical in establishing a decentralized and trust-independent framework that eliminates reliance on central repositories and reduces risks associated with centralized vulnerabilities.

Following the generation of the DID, the system transitions to the creation of a DID document, represented as 302. This document aggregates key metadata linked to the DID, including public keys and service endpoints that enable seamless identity verification and system interoperability. The DID document standardizes the representation of identity-related information, making it easily retrievable and verifiable across diverse systems. The blockchain plays a pivotal role in this stage by storing the DID document and preserving its integrity, ensuring that all changes are transparent and recorded. This immutable storage mechanism strengthens trust in the system by providing a reliable basis for validating the identity of third-party entities during subsequent interactions.

The process progresses to the trustworthy identification phase, labeled as 304, where the system resolves the DID to access the associated DID document. During this resolution process, the system rigorously verifies the public keys and service endpoints contained within the document to confirm their authenticity and accuracy. By establishing a verified link between the DID and its associated metadata, the system guarantees that the identity data is both accurate and trustworthy. This step is instrumental in preventing unauthorized access, as it ensures that the credentials presented by a third party are valid and correspond to a legitimate identity.

Verifiable credentials (VCs) are a central feature of this architecture, and their issuance is depicted as 306. In this phase, a trusted entity, such as a bank, regulatory body, or similar authority, provides critical inputs about the entity seeking credentials. These inputs may include roles, permissions, or other attributes necessary for defining the scope of access and interactions. Based on this information, the system generates a verifiable credential that is cryptographically signed using the trusted authority's private key. This signature ensures the authenticity of the credential and secures it against tampering. The verifiable credential is then stored on the blockchain, where it remains immutable and easily verifiable. The inclusion of these credentials within the blockchain enhances the system's ability to enforce precise access controls, ensuring that only authorized actions and interactions are permitted.

The verifiable credential presentation phase, illustrated as 308, facilitates the secure use of these credentials by third-party entities. In this stage, the user or client presents their VC when requesting access to internal systems or resources. The API gateway or verification system validates the VC by cross-referencing it with the issuer's public keys and metadata stored on the blockchain. This validation process is robust, ensuring that the credential has not been altered and originates from a trusted authority. The system also checks the permissions and roles encoded within the VC to confirm that the requested access aligns with the authorized privileges. This process provides a fine-grained approach to access control, allowing for dynamic and situation-specific permissions.

The immutable ledger, represented as 310, serves as a critical component of the system by recording all DIDs, public keys, credentials, and identity-related transactions. This ledger provides an unalterable history of all actions and changes within the system, ensuring transparency and enabling comprehensive audits. The immutability of the ledger supports compliance with regulatory requirements by providing verifiable records of identity interactions. It also facilitates forensic investigations in the event of security breaches or disputes, as all identity transactions are securely logged and preserved.

The final phase of the process flow emphasizes distributed trust, shown as 312. This phase validates the decentralized nature of the blockchain, ensuring that no single entity controls or manipulates the identity data. By distributing control across multiple nodes within the blockchain network, the system reduces the risk of systemic failures and enhances its overall resilience. The distributed nature of the architecture fosters trust among all stakeholders by demonstrating that the system operates transparently and equitably.

This process flow encapsulates the innovative and multifaceted nature of the blockchain-enabled system for identity management. Each stage contributes to a cohesive framework that addresses critical challenges such as unauthorized access, data breaches, and operational inefficiencies. The system's reliance on advanced cryptographic methods, immutable blockchain technology, and decentralized principles establishes a new paradigm for managing identities in complex digital ecosystems. By providing a secure, transparent, and user-centric approach to identity management, the architecture depicted in FIG. 3 demonstrates the potential to revolutionize how identities are verified, managed, and protected across diverse industries. This detailed description reflects and expands upon the claims, showcasing the system's ability to generate decentralized identifiers, issue verifiable credentials, and maintain a secure, immutable, and transparent audit trail for identity-related activities.

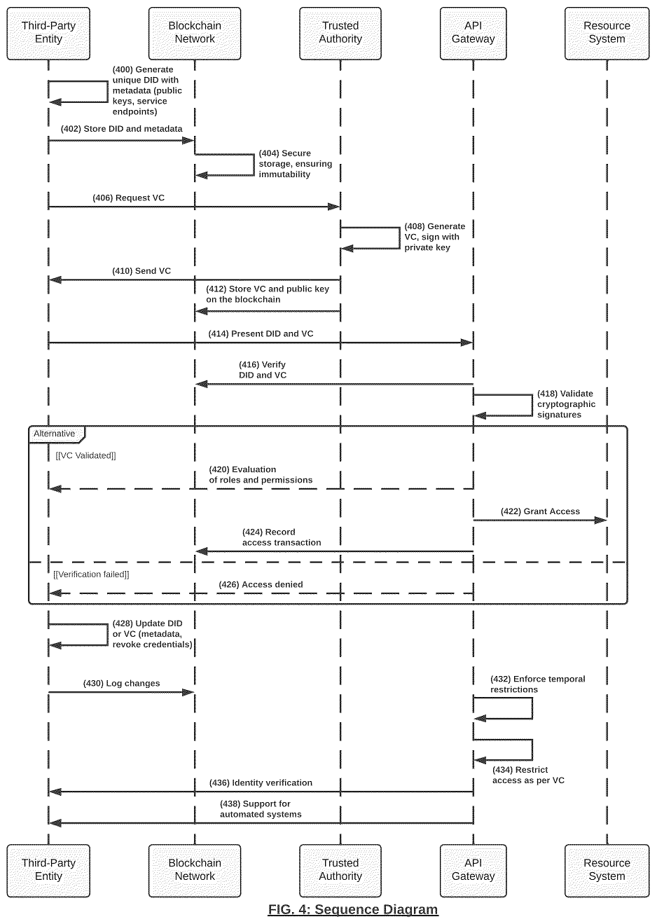

FIG. 4 illustrates an intricate sequence diagram that meticulously maps the interactions among the key components of a blockchain-enabled decentralized identity management and access control system. The process initiates with the Third-Party Entity, which generates a unique decentralized identifier, or DID, as depicted by step 400. This DID is crafted using a cryptographic key pair to ensure that it is both unique and secure, with associated metadata including public keys and service endpoints. These metadata elements are integral to enabling seamless identity verification and facilitating interoperability across various systems. Once the DID is generated, the Third-Party Entity securely transmits it, along with its metadata, to the Blockchain Network for storage, as shown in step 402. The Blockchain Network, a distributed ledger system, then undertakes the task of ensuring that the DID and its metadata are securely stored in an immutable and tamper-proof manner, as indicated by step 404. The immutability of this storage ensures that the identity data remains incorruptible, providing a solid foundation for subsequent identity validation processes.

Following the storage of the DID, the Third-Party Entity interacts with the Trusted Authority to request the issuance of a verifiable credential, or VC, as detailed in step 406. The Trusted Authority, which is a recognized and reliable source such as a regulatory body or financial institution, processes this request by generating a VC that encodes critical attributes such as roles, permissions, and other identifiers of the entity. In step 408, the Trusted Authority cryptographically signs the VC with its private key, ensuring its authenticity and integrity. This step is fundamental to establishing a trusted linkage between the entity's identity and the permissions granted. Once generated and signed, the VC is transmitted back to the Third-Party Entity in step 410. To maintain its verifiability and integrity, the Trusted Authority also stores the VC, along with its public key, on the Blockchain Network as represented in step 412. This ensures that the VC remains tamper-proof and can be validated against the public key at any time.

In step 414, the Third-Party Entity presents its DID and VC to the API Gateway to request access to a specific resource managed by the system. The API Gateway acts as an intermediary, initiating the verification of both the DID and VC in step 416 by querying the Blockchain Network. The verification process in step 418 involves the validation of cryptographic signatures to confirm that the credentials have not been tampered with and originate from the Trusted Authority. The sequence diagram includes an alternative outcome pathway, where the verification may either succeed, leading to further evaluation, or fail, resulting in access denial. If successful, the API Gateway proceeds to step 420, where it evaluates the roles, permissions, and temporal restrictions encoded in the VC to determine whether the requested access aligns with the system's predefined policies.

Once the evaluation is complete, the API Gateway either grants or denies access based on the findings. In the case of successful verification and alignment with the policies, access is granted in step 422, and the resource system is notified to provide the requested functionality. Simultaneously, in step 424, the Blockchain Network records the details of the access transaction, including the DID, the timestamp, and the accessed resource. This record is stored in an immutable format, creating an auditable trail that ensures compliance with regulatory standards and enables transparency in identity management activities. Conversely, if verification fails or the VC's permissions do not authorize the requested access, the system denies access, as indicated in step 426.

In addition to managing access, the system allows the Third-Party Entity to self-manage its identity credentials. In step 428, the entity can update its DID or VC, including modifications to metadata, revocations of credentials, or generation of new cryptographic keys. These updates are securely logged on the Blockchain Network in step 430, preserving the integrity and traceability of all identity-related changes. Temporal restrictions encoded in the VC are enforced by the API Gateway in step 432, ensuring that access is limited to predefined durations. This feature is critical for scenarios where temporary or time-bound access is required, such as during audits or project collaborations.

The system further ensures granular access control in step 434, where the API Gateway restricts the entity's interactions to specific data fields, operations, or resources as defined in the VC. This level of precision minimizes the risk of unauthorized access or misuse while enabling compliance with strict governance and data protection standards. The sequence also addresses the accommodation of both human users and automated systems. In step 436, the system provides identity verification and session management capabilities for human users, while in step 438, it supports automated systems by enabling secure and efficient API-based credential validation. This dual capability ensures that the system can handle a wide range of use cases, from individual access requests to large-scale, automated interactions.

Through its detailed depiction of these steps, FIG. 4 encapsulates the system's robust approach to decentralized identity management. By integrating cryptographic security, blockchain immutability, and fine-grained access control, the sequence diagram demonstrates how the system addresses key challenges such as unauthorized access, data tampering, and operational inefficiencies. Each numbered step contributes to a cohesive and secure framework that enables scalable, transparent, and efficient identity management across diverse and complex digital ecosystems. The diagram's comprehensive nature reflects the claims of the invention, highlighting the innovative interplay between decentralized identifiers, verifiable credentials, and blockchain technology in creating a transformative identity management solution.

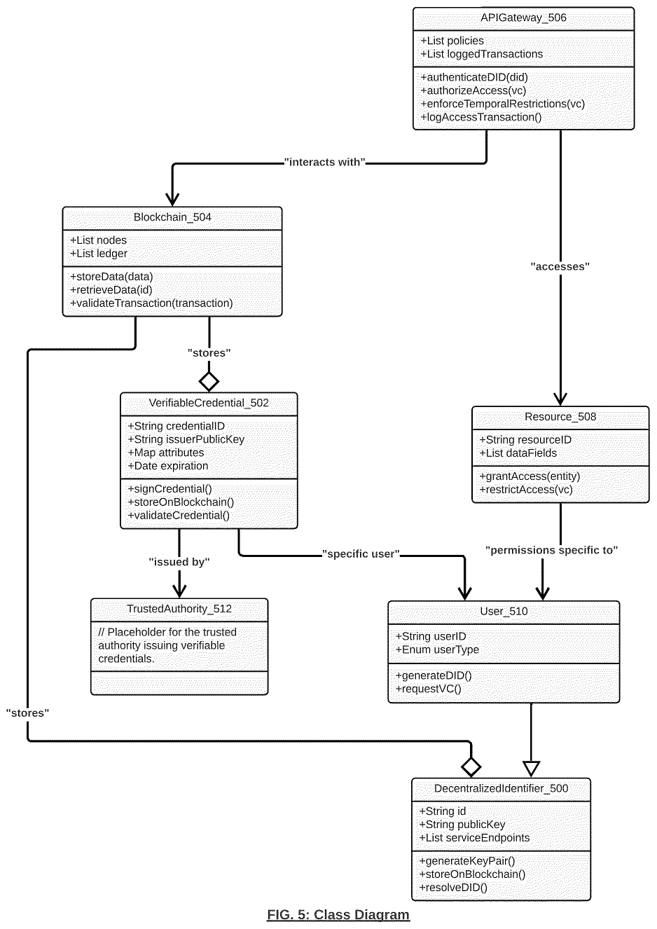

FIG. 5 provides a highly detailed class diagram illustrating the interconnected components of a blockchain-enabled decentralized identity management and access control system. Central to the diagram is the DecentralizedIdentifier class, labeled as 500, which encapsulates the foundational elements required for managing unique and cryptographically secure identities. This class includes attributes such as ‘id’, a string that uniquely identifies the third-party entity, ‘publicKey’, which is associated with the cryptographic key pair used to authenticate and verify the entity, and ‘serviceEndpoints’, a list that specifies endpoints for interactions between the entity and the system. The methods of this class are critical for implementing decentralized identity functionality. The ‘generateKeyPair( )’ method ensures that cryptographic key pairs are generated securely, enabling unique and verifiable DIDs. The ‘storeOnBlockchain( )’ method allows for the secure and immutable storage of the DID and its metadata on the blockchain network, ensuring that all identity information is tamper-proof and transparent. Finally, the ‘resolveDID( )’ method retrieves the metadata associated with a given DID, allowing the system to verify the identity during interactions with external components.

The VerifiableCredential class, labeled as 502, represents a mechanism for encoding permissions, roles, and attributes granted to a third-party entity. This class includes the ‘credentialID’, a unique identifier for each verifiable credential, which links it to a specific entity or set of permissions. The ‘issuerPublicKey’ attribute ties the credential to the trusted authority that issued it, ensuring its authenticity and origin. A ‘Map’ of attributes is included to encode roles and permissions in a structured format, while the ‘expiration’ attribute defines the temporal validity of the credential, ensuring that access rights are time-bound. The methods within this class include ‘signCredential( )’, which cryptographically signs the credential using the issuer's private key, ensuring its integrity and verifiability. The ‘storeOnBlockchain( )’ method securely stores the credential on the blockchain, making it immutable and readily accessible for verification. The ‘validateCredential( )’ method allows the system to verify the credential's authenticity by cross-referencing it with the trusted authority's public key stored on the blockchain, ensuring that it has not been tampered with or altered.

The Blockchain class, labeled as 504, serves as the backbone of the entire system, facilitating secure storage and retrieval of data while ensuring the immutability of all transactions. Its attributes include ‘nodes’, which represent the distributed participants within the blockchain network, and ‘ledger’, a list that records all transactions in a tamper-proof manner. The class includes critical methods such as ‘storeData(data)’, which allows any component of the system to write information to the blockchain, ensuring its integrity and availability. The ‘retrieveData(id)’ method retrieves specific data from the blockchain based on an identifier, enabling real-time access to identity and credential records. The ‘validateTransaction(transaction)’ method ensures the authenticity of all blockchain transactions by verifying cryptographic signatures and consistency across the distributed ledger.

The APIGateway class, labeled as 506, acts as the intermediary between third-party entities and internal systems, facilitating secure identity verification and access control. The attributes of this class include ‘policies’, which define the system's access control rules, and ‘loggedTransactions’, which maintain a record of all interactions with the gateway. Its methods are essential for enforcing security and operational protocols. The ‘authenticateDID(did)’ method verifies the identity of a user or system by validating the presented DID against blockchain records. The ‘authorizeAccess(vc)’ method determines whether access should be granted based on the permissions and roles encoded in the verifiable credential. The ‘enforceTemporalRestrictions(vc)’ method ensures that access is provided only within the time limits specified in the credential's expiration attribute, while the ‘logAccessTransaction( )’ method records all access attempts on the blockchain, ensuring transparency and accountability.

The Resource class, labeled as 508, defines the data and operational endpoints managed by the system. Its attributes include ‘resourceID’, a unique identifier for each resource, and ‘dataFields’, a list of specific fields that are accessible to authorized users. The ‘grantAccess(entity)’ method enables authorized entities to interact with the resource, while the ‘restrictAccess(vc)’ method enforces granular access control by validating the roles and permissions encoded in the verifiable credential. This ensures that third-party entities can only access the data fields and perform the operations for which they are explicitly authorized.

The User class, labeled as 510, represents the individuals or automated systems interacting with the system. Its attributes include ‘userID’, a unique identifier for each user, and ‘userType’, an enumeration that distinguishes between human users and automated systems such as software agents or APIs. The class includes methods like ‘generateDID( )’, which allows users to create decentralized identifiers, and ‘requestVC( )’, which enables them to obtain verifiable credentials from a trusted authority, linking them to specific roles and permissions.

The TrustedAuthority class, labeled as 512, is responsible for issuing verifiable credentials. While the attributes and methods for this class are placeholders in the diagram, its role is pivotal in establishing trust within the system by acting as the source of cryptographic signatures and ensuring the authenticity of all issued credentials. The class diagram also includes explicit relationships between the classes. The Blockchain class stores instances of DecentralizedIdentifier and VerifiableCredential, creating a central repository for immutable identity and credential records. The User class interacts with DecentralizedIdentifier and VerifiableCredential to manage identity and access permissions. The APIGateway class communicates with the Blockchain to authenticate identities and enforce access control while interacting with the Resource class to facilitate secure data exchange. The TrustedAuthority class connects to VerifiableCredential to issue and validate credentials, anchoring the entire trust framework of the system.

Overall, the class diagram depicted in FIG. 5 provides a detailed and interconnected representation of the system's components, their functionalities, and their roles in enabling secure, decentralized identity management and access control. It aligns seamlessly with the claims, emphasizing robust cryptographic security, immutable storage, and fine-grained access permissions, creating a scalable and transparent framework suitable for diverse applications.

Pseudocode exemplars for implementing various aspects of this disclosure are set forth below with explanations for reference.
#Decentralized Identifier (DID) Generation
function generate_did(user_data):
   public_key, private_key=generate_key_pair( )
   did=hash(public_key+user_data)
   metadata={
      “public_key”: public_key,
      “service_endpoints”: retrieve_service_endpoints(user_data)
   }
   return did, private_key, metadata
#Storing DID and Metadata on Blockchain
function store_did_on_blockchain(did, metadata):
   transaction={
      “type”: “DID_Storage”,
      “did”: did,
      “metadata”: metadata
   }
   blockchain.store(transaction)
   return transaction_id
#Verifiable Credential (VC) Issuance
function issue_verifiable_credential(entity, attributes, private_key, issuer_id):
   credential={
      “id”: generate_uuid( ),
      “issuer_id”: issuer_id,
      “attributes”: attributes,
      “expiration”: generate_expiration_date( )
   }
   credential_signature=sign_data(credential, private_key)
   credential[“signature”]=credential_signature
   return credential
#Storing VC on Blockchain
function store_vc_on_blockchain(vc, issuer_public_key):
   transaction={
      “type”: “VC_Storage”,
      “vc”: vc,
      “issuer_public_key”: issuer_public_key
   }
   blockchain.store(transaction)
   return transaction_id
#Access Request Presentation
function present_access_request(did, vc, api_gateway):
   request={
      “did”: did,
      “vc”: vc
   }
   response=api_gateway.verify_request(request)
   return response
#Verification of DID and VC
function verify_did_and_vc(request, blockchain):
   did_record=blockchain.retrieve(“DID”, request[“did”])
   vc_record=blockchain.retrieve(“VC”, request[“vc”][“id”])
      valid_did=validate_signature(did_record[“metadata”] [“public_key”], request[“did”])
      valid_vc=validate_signature(vc_record[“issuer_public_key”], request[“vc”])
   if valid_did and valid_vc:
      return True
   return False
#Access Control
function determine_access_permissions(vc, access_policy):
   roles=vc[“attributes”][“roles”]
   permissions=access_policy.get(roles, [])
   if vc[“expiration”]>current_time( ) and permissions:
      return permissions
   return []
#Granting or Denying Access
function grant_access(api_gateway, resource, permissions):
   if permissions:
      api_gateway.grant_access(resource, permissions)
      blockchain.store_access_transaction(resource, permissions)
      return “Access Granted”
   return “Access Denied”
#Immutable Audit Trail
function store_access_transaction(resource, permissions):
   transaction={
      “type”: “Access_Record”,
      “resource”: resource,
      “permissions”: permissions,
      “timestamp”: current_time( )
   }
   blockchain.store(transaction)
#DID and VC Self-Management
function update_did_or_vc(did, vc, updates, blockchain):
   if updates[“metadata”]:
      did[“metadata”].update(updates[“metadata”])
      blockchain.update(“DID”, did)
   if updates[“vc”]:
      vc.update(updates[“vc”])
      vc[“signature”]=sign_data(vc, private_key)
      blockchain.update(“VC”, vc)
   return “Update Successful”
#Enforcing Temporal Restrictions
function enforce_temporal_restrictions(vc):
   if current_time( )>vc[“expiration”]:
      return “Access Denied: VC Expired”
   return “Access Permitted”

The pseudocode begins with the generation of a Decentralized Identifier (DID) through the ‘generate_did’ function. This function uses cryptographic methods to create a key pair, ensuring the DID is unique and secure. Metadata such as public keys and service endpoints are associated with the DID. The DID and metadata are then stored immutably on a blockchain via the ‘store_did_on_blockchain’ function, which packages the data into a transaction and adds it to the distributed ledger, ensuring tamper-proof storage.

Verifiable Credentials (VCs) are issued by a trusted authority using the ‘issue_verifiable_credential’ function. The VC includes attributes like roles and expiration details, signed cryptographically to ensure its integrity. This credential is then securely stored on the blockchain using ‘store_vc_on_blockchain’, enabling future validation against the issuer's public key.

When a third-party entity requests access to a resource, it presents its DID and VC to the API Gateway through the ‘present_access_request’ function. The API Gateway verifies the request by querying the blockchain to validate both the DID and VC using the ‘verify_did_and_vc’ function. This ensures that the presented credentials match the immutable records stored on the blockchain and have not been tampered with.

Access permissions are determined based on the roles and attributes encoded in the VC through the ‘determine_access_permissions’ function. This function compares the VC data with predefined access policies, ensuring permissions are granted only if the credentials meet the criteria and have not expired. Based on the permissions, the API Gateway either grants or denies access through the ‘grant_access’ function. If granted, the access transaction is recorded on the blockchain to create an immutable audit trail, enabling transparency and accountability.

Self-management capabilities are implemented in the ‘update_did_or_vc’ function, allowing entities to update their credentials or metadata as needed. These updates are cryptographically signed and logged on the blockchain, ensuring integrity and traceability. Temporal restrictions are enforced via the ‘enforce_temporal_restrictions’ function, which checks whether the VC's expiration has passed and denies access if the credential is no longer valid.

This pseudocode captures all aspects of the invention, detailing the processes for generating, storing, validating, managing, and enforcing decentralized identity and access control using blockchain technology.

A skilled artisan, upon reviewing the disclosure, will appreciate that there are numerous alternatives, modifications, combinations, and customizations that can be made to the systems and methods described herein.

The systems and methods described herein can be adapted and extended in numerous ways to address varying use cases, implementation constraints, and technological advancements, while remaining within the spirit and scope of the disclosure. The alternatives, modifications, combinations, and customizations that could be applied include, but are not limited to, the following:

One possible modification involves the use of alternative distributed ledger technologies beyond blockchain, such as directed acyclic graphs (DAGs) or Holochain. These alternatives could enhance scalability and reduce latency for applications requiring high-throughput identity transactions. Similarly, the consensus mechanism used in the blockchain network could be customized, with options like proof-of-stake, proof-of-authority, or hybrid models, replacing proof-of-work to achieve greater energy efficiency or align with specific regulatory requirements.

Another alternative lies in the expansion of metadata associated with decentralized identifiers. Additional metadata fields, such as biometric data hashes or geolocation tags, could be included to provide multi-factor authentication capabilities or geographic access restrictions. Likewise, the service endpoints within the DID metadata could be dynamically configurable to support edge computing environments or adapt to decentralized application (dApp) ecosystems.

Verifiable credentials could be customized to support more granular attribute encoding, such as integrating zero-knowledge proof methods. This modification would allow entities to prove possession of certain attributes or roles without disclosing sensitive information, enhancing privacy while maintaining trust. Similarly, the expiration attributes in verifiable credentials could be adapted to include conditions beyond time, such as usage limits or specific event triggers.

Customizations could also focus on integrating advanced cryptographic techniques such as post-quantum cryptography for securing DIDs and VCs. This enhancement would future-proof the system against threats posed by quantum computing. Additionally, homomorphic encryption could be employed to enable secure processing of encrypted identity data, allowing access permissions to be evaluated without decrypting the underlying credentials.

The API Gateway could be enhanced to include machine learning algorithms that adapt access control policies dynamically based on observed usage patterns and potential threats. This would allow for real-time risk assessments and fine-grained permissions based on contextual analysis. Integration with external threat intelligence feeds could further bolster the security posture of the system.

Combining the described systems with federated identity frameworks could create hybrid models where decentralized identities coexist with centralized or hierarchical identity systems. This would facilitate compatibility with legacy systems and ensure a smoother transition for organizations adopting decentralized identity management. For example, decentralized identifiers could be integrated with single sign-on (SSO) systems to streamline user experiences.

The system could also be adapted to support non-traditional use cases, such as Internet of Things (IoT) devices or autonomous agents. DIDs could be extended to represent devices, and verifiable credentials could encode operational policies or usage rights, enabling secure and autonomous interactions in IoT ecosystems. Similarly, combining the methods with decentralized finance (DeFi) applications could open opportunities for secure and transparent identity verification in financial transactions.

Modifications could include introducing cross-chain interoperability protocols, enabling identity data to be securely shared and verified across multiple blockchain networks. This would allow entities operating in multi-blockchain environments to leverage decentralized identity solutions without being confined to a single network.

The system could be customized for regulatory compliance by integrating audit trails and reporting modules tailored to specific jurisdictions or industries, such as finance or government. These modules could provide stakeholders with transparent insights into identity usage, ensuring adherence to privacy and security regulations.

To improve usability, user interfaces and developer APIs could be customized to simplify interactions with the system. For example, SDKs (Software Development Kits) could be provided to streamline the integration of decentralized identity management into third-party applications. Similarly, user-friendly mobile applications could empower end-users to manage their DIDs and verifiable credentials effortlessly.

Overall, the described systems and methods offer a versatile framework that can be tailored to various applications and industries. The proposed alternatives, modifications, combinations, and customizations enhance functionality, scalability, security, and usability, ensuring the system remains adaptable to emerging needs and technological landscapes while maintaining the integrity of the core principles of the disclosure.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for decentralized identity management and access control, comprising:
generating, by a third-party entity, a decentralized identifier (DID) using a cryptographic key pair, wherein the DID is unique to the entity and includes associated metadata, including public keys and service endpoints;
storing, by a blockchain network, the generated DID and its associated metadata on a distributed ledger, ensuring immutability and tamper-proof storage;
issuing, by a trusted authority, a verifiable credential (VC) to the third-party entity, wherein the VC encodes attributes, roles, or permissions of the entity and is cryptographically signed using a trusted authority's private key;
storing, by the blockchain network, the issued VC on the distributed ledger along with a trusted authority's public key for verification purposes;
presenting, by the third-party entity, the DID and associated VC to an API gateway to request access to a resource;
verifying, by the API gateway, authenticity of the DID and the VC by validating cryptographic signatures and comparing the DID and VC against the public keys stored on the blockchain network;
determining, by the API gateway, access permissions for the third-party entity based on the roles, attributes, and temporal restrictions encoded in the VC;
granting, by the API gateway, access to the requested resource if the VC and the DID are successfully verified and the permissions align with an access policy;
recording, by the blockchain network, an access transaction, including the third-party entity's DID, timestamp, and the accessed resource, to create an immutable audit trail;
enabling, by the third-party entity, self-management of its DID and VC, including updating metadata, revoking credentials, or generating new cryptographic keys, with all changes securely logged on the blockchain network;
enforcing, by the API gateway, temporal restrictions encoded in the VC, including limiting duration of access based on predefined expiration times;
providing, by a system, granular access control by restricting a third-party entity's interactions to specific data fields, resources, or operations as defined in the VC and verified by the API gateway; and
accommodating, by the system, both human users and automated systems by enabling secure identity verification, session management, and API-based credential validation for non-human entities.

2. The method of claim 1, wherein the decentralized identifier (DID) generated by the third-party entity includes a cryptographic checksum to ensure data integrity and prevent unauthorized modifications.

3. The method of claim 2, wherein the cryptographic key pair used to generate the DID comprises an elliptic curve cryptography (ECC) key pair to enhance security and reduce computational overhead.

4. The method of claim 3, wherein the blockchain network storing the DID and its associated metadata is implemented as a permissioned blockchain to ensure that only authorized participants can contribute to or access the ledger.

5. The method of claim 4, wherein the trusted authority issuing the verifiable credential (VC) includes additional metadata, such as expiration dates, scope of access, and data usage policies, to enhance granularity in access control.

6. The method of claim 5, wherein the VC includes cryptographically encoded temporal constraints, allowing access to the requested resource only during a predefined timeframe.

7. The method of claim 6, wherein the VC is verified by the API gateway using a zero-knowledge proof protocol to enhance privacy by minimizing exposure of sensitive credential details during a verification process.

8. The method of claim 7, wherein the API gateway is configured to interface with multiple blockchain networks to validate decentralized identifiers and verifiable credentials issued by different trusted authorities.

9. The method of claim 8, wherein the API gateway enforces multi-factor authentication for the third-party entity before granting access to the requested resource, enhancing security.

10. The method of claim 9, wherein the access transaction recorded on the blockchain network includes cryptographic hash values of the accessed data to ensure verifiable and immutable records without exposing sensitive data content.

11. The method of claim 10, wherein the third-party entity is enabled to update its DID metadata by generating a new cryptographic key pair and linking it to an existing DID through a blockchain-stored transaction, ensuring continuity of identity.

12. The method of claim 11, wherein the system supports revocation of the VC by the trusted authority, which is recorded as a transaction on the blockchain network to invalidate the credential while preserving its historical record.

13. The method of claim 12, wherein the system includes a decentralized identity resolver capable of querying the blockchain network to retrieve the DID, associated metadata, and VC for verification by any entity.

14. The method of claim 13, wherein the system provides a role-based access control mechanism encoded in the VC, defining specific actions the third-party entity can perform on the resource.

15. The method of claim 14, wherein the system implements a dynamic policy update mechanism, allowing modifications to access control policies stored on the blockchain network without disrupting existing credentials or ongoing transactions.

16. A method for decentralized identity management and access control, comprising:
generating, by a third-party entity, a decentralized identifier (DID) using a cryptographic key pair comprising an elliptic curve cryptography (ECC) key pair, wherein the DID is unique to the entity and includes associated metadata, including public keys, service endpoints, cryptographic checksums for data integrity, and an identifier schema that ensures interoperability with standardized identity frameworks;
securely transmitting, by the third-party entity, the generated DID and associated metadata to a permissioned blockchain network for storage, wherein the blockchain network verifies the integrity of transmitted data using the cryptographic checksum before committing the data to an immutable distributed ledger accessible only by authorized participants;
issuing, by a trusted authority, a verifiable credential (VC) to the third-party entity, wherein the VC cryptographically encapsulates attributes, roles, permissions, expiration dates, temporal constraints, data usage policies, access hierarchies, and a unique cryptographic identifier linking the VC to the corresponding DID, and the VC is digitally signed using a private key of the trusted authority to ensure authenticity;
storing, by the blockchain network, the issued VC along with a trusted authority's public key, a cryptographic timestamp, and metadata indicating conditions under which the VC can be used, creating a tamper-proof record that allows for real-time validation and revocation;
presenting, by the third-party entity, the DID and associated VC to an API gateway to request access to a resource, wherein the presentation includes a proof of possession of an associated private key for additional security;
verifying, by the API gateway, the authenticity and integrity of the DID and VC by validating cryptographic signatures, checking against the trusted authority's public key stored on the blockchain network, and optionally performing a zero-knowledge proof protocol to verify credential claims without revealing sensitive information;
determining, by the API gateway, access permissions for the third-party entity by evaluating the roles, attributes, and constraints encoded in the VC, including verifying temporal constraints through cryptographic timestamps and ensuring the permissions align with predefined resource access policies;
enforcing, by the API gateway, multi-factor authentication for the third-party entity, combining VC-based identity verification with additional authentication factors, such as one-time passwords or biometric verification, to enhance the security of resource access;
granting, by the API gateway, access to the requested resource only if the VC and DID are successfully verified, the roles and permissions match the resource policy, and the temporal constraints encoded in the VC allow for current access;
recording, by the blockchain network, an access transaction in an immutable audit log, including the DID of the third-party entity, the timestamp of access, the identifier of the accessed resource, cryptographic hash values of transaction data, and additional metadata to provide an unalterable history of access events while preserving data confidentiality;
enabling, by the third-party entity, self-management of its DID and VC, including generating a new cryptographic key pair, securely linking the new key pair to the existing DID, and updating associated metadata such as service endpoints or access endpoints, with all updates recorded as blockchain transactions to maintain a continuous and verifiable identity history;
revoking, by the trusted authority, the VC when required due to security, expiration, or policy changes, wherein the revocation is recorded as a blockchain transaction that invalidates the VC while preserving its historical record for audit and compliance purposes;
querying, by a decentralized identity resolver, the blockchain network to retrieve the DID, associated metadata, VC, and any updates or revocation records, ensuring that the resolver provides verified and consistent identity data to authorized requesters without compromising privacy;
defining, by a system, granular role-based access control policies encoded in the VC, specifying detailed permissions for actions that the third-party entity is authorized to perform on the requested resource, including restrictions at a data field or operational level;
implementing, by the system, a dynamic policy update mechanism that allows authorized administrators to modify access control policies stored on the blockchain network, including updates to roles, permissions, temporal constraints, or resource hierarchies, without invalidating existing credentials or disrupting ongoing transactions;
facilitating, by the system, interoperability with multiple blockchain networks and identity standards, ensuring that the method supports cross-platform verification of DIDs and VCs issued by diverse trusted authorities while maintaining consistent security and compliance protocols; and
supporting, by the system, automated reconciliation of access logs and identity transactions across blockchain nodes, enabling efficient compliance reporting, anomaly detection, and resolution of disputes related to third-party access and identity management.

17. A system for decentralized identity management and access control, comprising:
a decentralized identifier (DID) generator, configured to generate, by a third-party entity, a unique DID using a cryptographic key pair, wherein the DID includes associated metadata comprising public keys, service endpoints, cryptographic checksums for data integrity, and an identifier schema for interoperability;
a blockchain network, configured to store the generated DID and associated metadata on an immutable distributed ledger, verify the integrity of the data using the cryptographic checksum, and ensure tamper-proof, authorized access to stored information by permissioned participants;
a trusted authority module, configured to issue verifiable credentials (VCs) to the third-party entity, wherein VCs cryptographically encode attributes, roles, permissions, expiration dates, temporal constraints, data usage policies, and a unique cryptographic link to an associated DID, and are digitally signed using a private key of the trusted authority;
a blockchain storage module, integrated with the blockchain network, configured to store the issued VCs, a trusted authority's public key, cryptographic timestamps, and usage conditions, creating a verifiable, tamper-proof record for real-time validation and revocation;
an API gateway, configured to interface with the blockchain network and third-party entities, verify authenticity of a presented DID and VC using a blockchain-stored public keys, validate cryptographic signatures, and optionally perform zero-knowledge proof protocols to confirm credential claims without exposing sensitive information;
an access control engine, integrated with the API gateway, configured to evaluate roles, attributes, temporal constraints, and permissions encoded in the VCs, compare these against predefined access policies, and determine whether to grant or deny resource access;
a multi-factor authentication module, coupled to the API gateway, configured to enforce additional authentication requirements, such as one-time passwords or biometric verification, before granting access to ensure enhanced security;
a transaction logging module, integrated with the blockchain network, configured to record all access transactions, including the third-party entity's DID, timestamps, identifiers of accessed resources, cryptographic hash values of transaction data, and additional metadata, creating an immutable audit trail for compliance and forensic analysis;
a self-management interface, accessible by the third-party entity, configured to enable the entity to manage its DID and VC, including generating new cryptographic key pairs, linking new keys to existing DIDs, and updating associated metadata, with all changes recorded as blockchain transactions to maintain identity continuity and transparency;
a revocation module, operated by the trusted authority, configured to revoke VCs due to expiration, security risks, or policy changes, and record the revocation as a blockchain transaction to invalidate the credential while preserving its historical record;
a decentralized identity resolver, configured to query the blockchain network to retrieve DIDs, associated metadata, VCs, and any revocation or update records, providing verified and consistent identity data to authorized requesters while maintaining privacy;
a role-based access policy manager, configured to define granular access control policies encoded in the VCs, specifying detailed permissions for actions that third-party entities are authorized to perform, including restrictions at a data field, resource, or operational level;
a dynamic policy update module, integrated with the blockchain network, configured to enable authorized administrators to modify access control policies, including roles, permissions, temporal constraints, or resource hierarchies, without invalidating existing credentials or disrupting ongoing transactions;
a cross-platform compatibility module, configured to ensure interoperability with multiple blockchain networks and identity standards, enabling cross-platform verification of DIDs and VCs issued by diverse trusted authorities while maintaining consistent security protocols; and
an automated reconciliation engine, integrated with the blockchain network, configured to reconcile access logs and identity transactions across blockchain nodes, enabling efficient compliance reporting, anomaly detection, and resolution of disputes related to third-party access and identity management.

18. The system of claim 17, wherein the blockchain network is implemented as a consortium blockchain with predefined governance rules, ensuring that only authorized participants from a consortium of trusted organizations, including regulatory bodies, financial institutions, and identity verification service providers, can contribute to or access the ledger, and wherein governance rules define data access permissions, consensus mechanisms, and dispute resolution protocols to ensure secure and transparent operations.

19. The system of claim 18, wherein the API gateway includes an adaptive authentication mechanism, configured to dynamically adjust authentication requirements for third-party entities based on contextual risk factors, including geolocation, device type, historical access behavior, real-time network conditions, and the sensitivity of a requested resource, wherein the adaptive mechanism employs machine learning algorithms to continuously refine risk assessment and reduce false positives while maintaining security and usability.

20. The system of claim 19, wherein the transaction logging module integrates with an artificial intelligence-based anomaly detection system, configured to analyze access transactions in real time by comparing them against established behavioral baselines, identifying patterns indicative of unauthorized or suspicious activities such as unusual access locations, unexpected credential usage, or attempts to access restricted resources, and wherein the system automatically generates alerts, provides actionable insights to administrators, and executes preconfigured mitigation measures, including revoking access, initiating credential revocation workflows, or isolating compromised entities from critical resources.
